(19) United States
(12) Patent Application Publication
(10) Pub. No.: US 2025/0087164 A1
(43) Pub. Date: Mar. 13, 2025

(54) DISPLAY DEVICES

(71) Applicant: WUHAN CHINA STAR OPTOELECTRONICS SEMICONDUCTOR DISPLAY TECHNOLOGY CO., LTD., Wuhan, Hubei (CN)

(72) Inventor: Tao CHEN, Wuhan, Hubei (CN)

(73) Assignee: WUHAN CHINA STAR OPTOELECTRONICS SEMICONDUCTOR DISPLAY TECHNOLOGY CO., LTD., Wuhan, Hubei (CN)

(21) Appl. No.: 18/552,938

(22) PCT Filed: Jul. 31, 2023
(86) PCT No.: PCT/CN2023/110126

§ 371 Date: Sep. 28, 2023

(30) Foreign Application Priority Data
Jul. 12, 2023 (CN) 202310856479.8

(51) Int. Cl. G09G 3/3266; G09G 3/3233

(52) U.S. Cl. CPC G09G 3/3266; G09G 3/3233; G09G 2300/0842; G09G 2300/0861; G09G 2310/0286; G09G 2310/08

(57) ABSTRACT

The present disclosure provides a display device including a display panel and a plurality of gate driving units. The plurality of gate driving units at least include a first gate driving unit and a second gate driving unit electrically connected to a plurality of subpixels of the display panel and sharing a clock signal and a power supply signal. A plurality of cascaded first gate driving circuits included in the first gate driving unit and a plurality of cascaded second gate driving circuits included in the second gate driving unit are alternately arranged in a first direction.

This application claims priority to Chinese Patent Application with the application Ser. No. 202310856479.8 and the title “DISPLAY DEVICES” filed on Jul. 12, 2023. The aforementioned application is herein incorporated by references in its entirety.

### TECHNICAL FIELD

The present disclosure relates to the field of display technologies, and in particular, to display devices.

### BACKGROUND

In existing display panels, gate driving units with the same function and structure are arranged in series to realize cascade transmission, and gate driving units with different functions are arranged in parallel, such as EM(m)˜EM(m+3) and Pscan(m)˜Pscan(m+3) as illustrated in FIG. 1. However, with the complexity of structural development of a pixel driving circuit, a number of the gate driving units that can realize different functions required by the pixel driving circuit also begins to increase. On a condition that the gate driving units realizing different functions continue to be arranged as illustrated in FIG. 1, a border area of the display panel will become wider, which is not conducive to a design of narrow border of the display panel.

### SUMMARY OF THE INVENTION

Embodiments of the present disclosure provide display devices, which are beneficial to realize the design of narrow border of display panels.

Display devices are provided according to embodiments of the present disclosure. The display device includes a display panel and a plurality of gate driving units. The display panel include a plurality of subpixels, each of the subpixels includes a light-emitting element and a pixel driving circuit electrically connected to the light-emitting element, and the pixel driving circuit includes a plurality of transistors. The plurality of gate driving units at least include a first gate driving unit and a second gate driving unit electrically connected to the plurality of subpixels and sharing a clock signal and a power supply signal. The first gate driving unit includes a plurality of cascaded first gate driving circuits and is configured to output a plurality of first scanning signals to the plurality of subpixels in response to a first startup signal, the clock signal, and the power supply signal. The second gate driving unit includes a plurality of cascaded second gate driving circuits and is configured to output a plurality of second scanning signals to the plurality of subpixels in response a second startup signal, the clock signal, and the power supply signal. Herein, each of the subpixels includes one of the transistors which is correspondingly turned on in response to a corresponding one of the first scanning signals and another one of transistors which is turned on in response to a corresponding one of the second scanning signals. The plurality of first gate driving circuits and the plurality of second gate driving circuits are alternately arranged in a first direction.

### BENEFICIAL EFFECTS

Compared with the related art, embodiments of the present disclosure provide display devices. The display device includes a display panel and a plurality of gate driving units, and the plurality of gate driving units at least include a first gate driving unit and a second gate driving unit electrically connected to the plurality of subpixels and sharing a clock signal and a power supply signal; the first gate driving unit and the second gate driving unit respectively receive a first start signal and a second start signal and respectively output a plurality of first scanning signals and a plurality of second scanning signals to a plurality of subpixels in cooperation with the clock signal and the power supply signal, so that each subpixel has one transistor turned on in response to a corresponding one of the first scanning signals, and has another transistor turned on in response to a corresponding one of the second scanning signals; and a plurality of cascaded first gate driving circuits included in the first gate driving unit and a plurality of cascaded second gate driving circuits included in the second gate driving unit are alternately arranged in a first direction. By arranging the plurality of first gate driving circuits and the plurality of second gate driving circuits alternately in the first direction, a width of a border of the panel is reduced, so as to facilitate a design of narrow border of the display device.

### DESCRIPTION OF DRAWINGS

FIG. 1 is a schematic diagram of an arrangement structure of a gate driving unit in related art;

FIG. 2A to FIG. 2C are schematic structural views of a display device provided according to embodiments of the present disclosure;

FIG. 3A and FIG. 3B are schematic structural views of a gate driving circuit provided according to embodiments of the present disclosure;

FIG. 4A to FIG. 4C are schematic structural views of a pixel driving circuit provided according to embodiments of the present disclosure;

FIG. 5A to FIG. 5C are timing diagrams provided according to embodiments of the present disclosure.

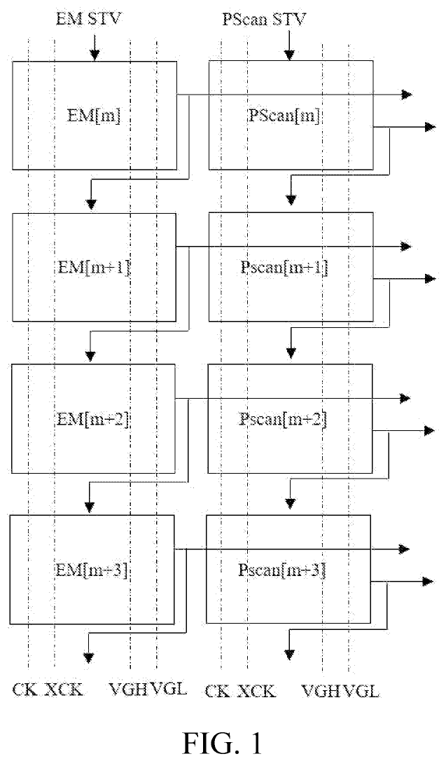

### EMBODIMENTS OF THE INVENTION

In order to make the purposes, technical solutions, and effects of the present disclosure clearer, the present disclosure will be further described in detail below with reference to the accompanying drawings and examples. It should be understood that the specific embodiments described here are only used to explain the present disclosure, not intended to limit the present disclosure.

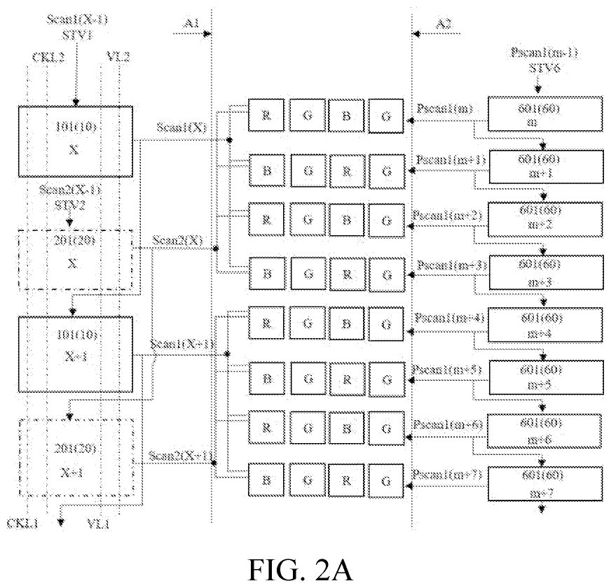

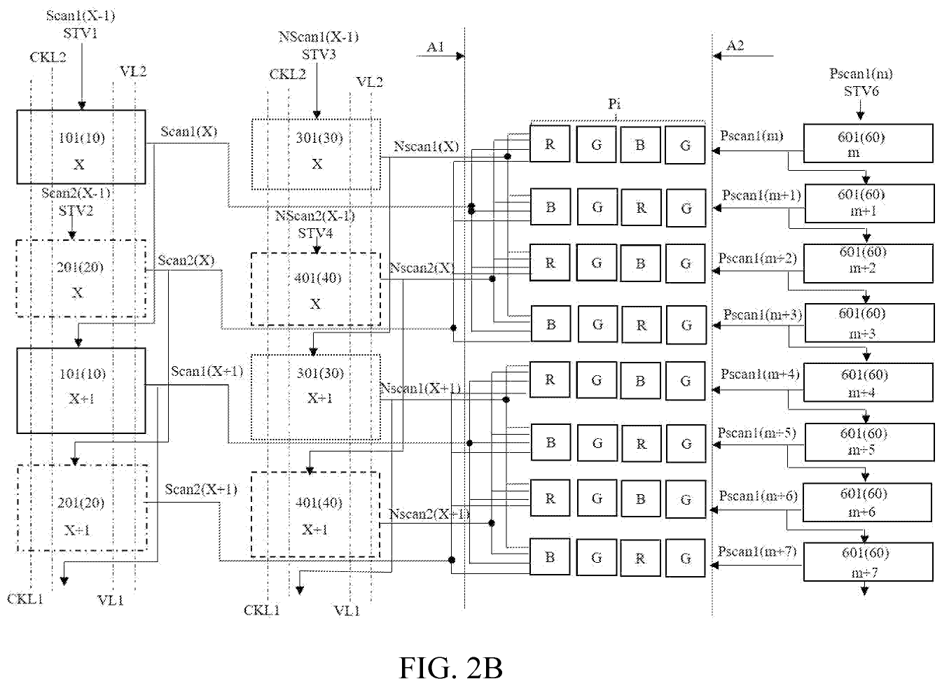

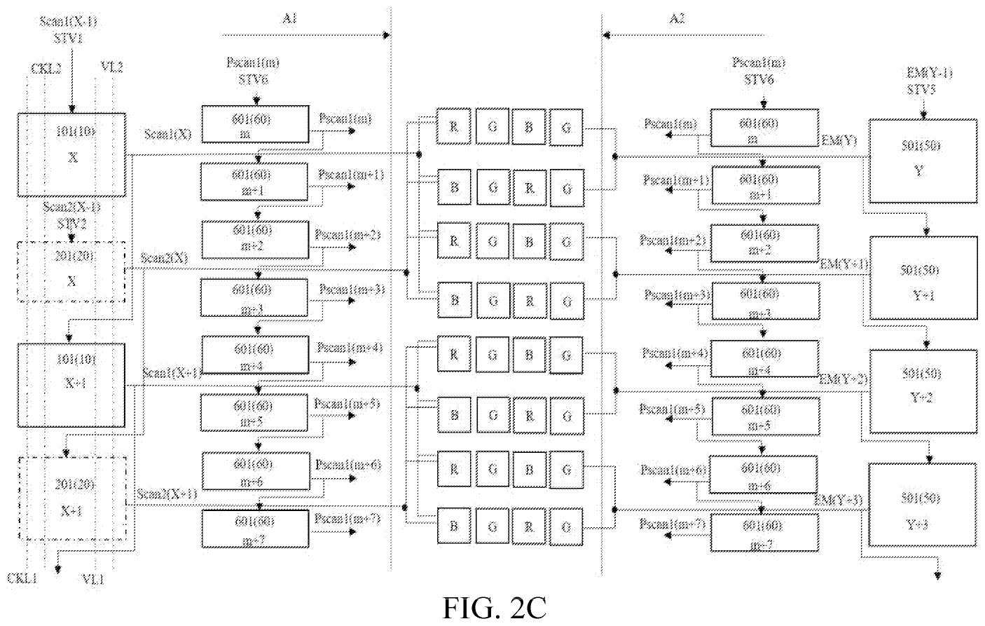

Specifically, FIG. 2A to FIG. 2C are schematic structural views of a display device provided according to embodiments of the present disclosure. The embodiment of the disclosure provides a display device, including a display panel and a plurality of gate driving units.

The display panel includes a plurality of subpixels Pi. Each subpixel Pi includes a light-emitting element L and a pixel driving circuit electrically connected to the light-emitting element L, and the pixel driving circuit is correspondingly configured to drive the light-emitting element L to emit light.

Optionally, the display panel includes a self-luminous display panel. The subpixels Pi include red subpixels R, green subpixels G, and blues subpixels B. The light-emitting element L is an organic light emitting diode, a submillimeter light emitting diode, a micro light emitting diode, or the like.

Optionally, the pixel driving circuit includes a plurality of transistors.

The plurality of gate driving units at least include a first gate driving unit 10 and a second gate driving unit 20, and the first gate driving unit 10 and second gate driving unit 20 are electrically connected to the plurality of subpixels Pi and share a clock signal and a power supply signal.

Optionally, the display device includes a first clock signal line CKL1, a second clock signal line CKL2, a first power supply line VL1, and a second power supply line VL2 electrically connected to the first gate driving unit 10 and the second gate driving unit 20. The first clock signal line CKL1, the second clock signal line CKL2, the first power supply line VL1 and the second power supply line VL2 all extend along a first direction. The first clock signal line CKL1 transmits a first clock signal CK, the second clock signal line CKL2 transmits a second clock signal XCK, and the clock signal includes the first clock signal CK and the second clock signal XCK. The first power supply line VL1 transmits a first power supply signal VGH, the second power supply line VL2 transmits a second power supply signal VGL, and the power supply signal includes the first power supply signal VGH and the second power supply signal VGL. The first clock signal CK and the second clock signal XCK are inverted, and a voltage corresponding to the first power supply signal VGH is greater than a voltage corresponding to the second power supply signal VGL.

The first gate driving unit 10 includes a plurality of cascaded first gate driving circuits 101, and the first gate driving unit 10 outputs a plurality of first scanning signals Scan1 to the plurality of subpixels Pi in response a first startup signal STV1, the clock signal, and the power supply signal.

The second gate driving unit 20 includes a plurality of cascaded second gate driving circuits 201, and the second gate driving unit 20 outputs a plurality of second scanning signals Scan2 to the plurality of subpixels Pi in response a second startup signal STV2, the clock signal, and the power supply signal.

Herein, each subpixel Pi includes one transistor turned on in response to a corresponding first scanning signal Scan1 and another transistor turned on in response to a corresponding second scanning signal Scan2. The plurality of first gate driving circuits 101 and the plurality of second gate driving circuits 201 are alternately arranged in the first direction. The first gate driving circuits 101 and the second gate driving circuits 201 that are electrically connected to the transistors with different functions in the pixel driving circuits are alternately arranged in the first direction, so that the gate driving unit 10 and the second gate driving unit 20 without a cascaded relationship show series characteristics, so as to relieve the problem of a larger border width of the display panel which is not conducive to realizing the narrow border of the display device due to that the cascaded gate driving circuits are arranged in series and the non-cascaded gate driving circuits are arranged in parallel in the related art.

Optionally, in order to reduce the complexity of layout design and the difficulty of manufacturing process, circuit topological structures of the gate driving circuits arranged alternately in the first direction and not cascaded are the same. For example, the circuit topological structures of the first gate driving circuit 101 and the second gate driving circuit 201 are the same.

Optionally, the circuit topological structures of the gate driving circuits arranged alternately in the first direction and not cascaded may also be different. Among them, that the circuit topological structures are different may refer to that the circuit topological structures (for example, the second gate driving circuit 201 may be to reduce or increase at least one transistor or at least one capacitor the basis of the first gate driving circuit 101) are similar or that the circuit topological structures are not similar (that is, the topological structure of the first gate driving circuit 101 is completely different from the topological structure of the second gate driving circuit 201).

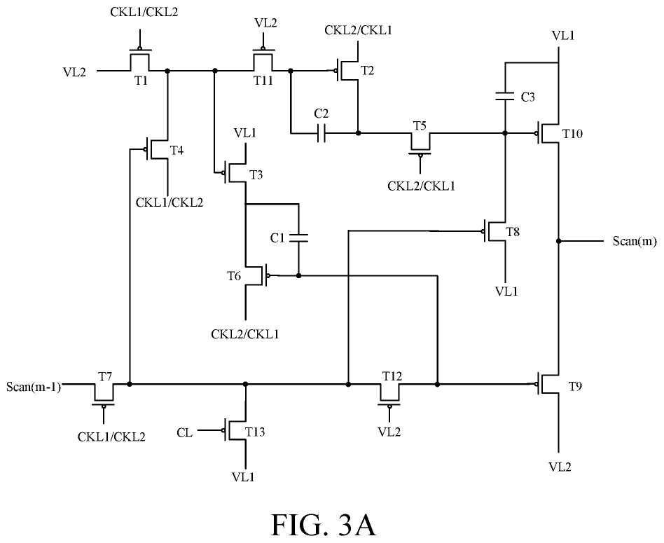

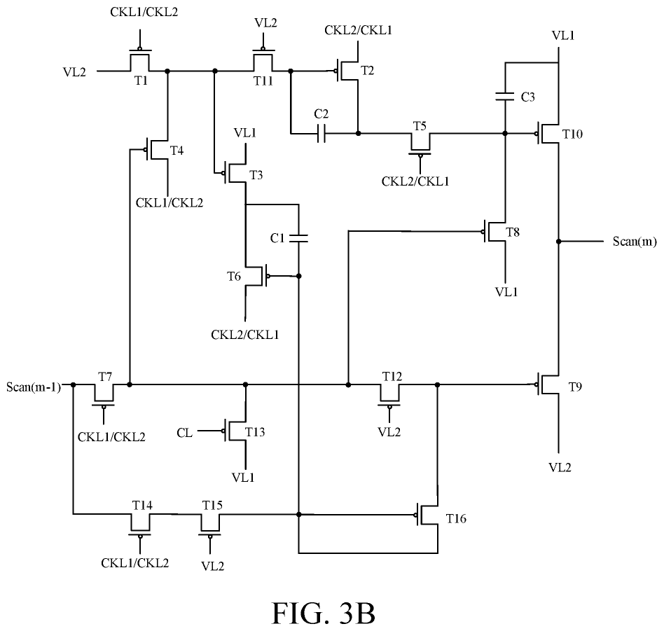

Optionally, FIG. 3A to FIG. 3B are schematic structural views of a gate driving circuit provided according to embodiments of the present disclosure. The gate driving circuit includes a first transistor T1 to a tenth transistor T10 and a first capacitor C1 to a third capacitor C3.

An input end of the first transistor T1 is electrically connected to the second power supply line VL2, and an output end of the first transistor T1 is electrically connected to a control end of the second transistor T2, a control end of the third transistor T3, and an output end of the fourth transistor T4. An output end of the second transistor T2 is electrically connected to an input end of the fifth transistor T5. An input end of the third transistor T3 is electrically connected to the first power supply line VL1, and an output end of the third transistor T3 is electrically connected to an output end of the sixth transistor T6. An input end of the seventh transistor T7 receives a start signal (such as a first start signal STV1, a second start signal STV2, or the scanning signal Scan(m−1) output by the gate driving circuit in an upper cascade, where m≥1), and an output end of the seventh transistor T7 is electrically connected to a control end of the fourth transistor T4, a control end of the sixth transistor T6, a control end of the eighth transistor T8, and a control end of the ninth transistor T9. An input end of the eighth transistor T8 is electrically connected to the first power supply line VL1, and an output end of the eighth transistor T8 is electrically connected to an output end of the fifth transistor T5 and a control end of the tenth transistor T10. An input end of the ninth transistor T9 is electrically connected to the second power supply line VL2, an input end of the tenth transistor T10 is electrically connected to the first power supply line VL1, and an output end of the ninth transistor T9 and an output end of the tenth transistor T10 are both electrically connected to a signal output end of the gate driving circuit, and the signal output end is configured to output a scanning signal (such as Scan(m)). The first capacitor C1 is connected in series between an output end of the sixth transistor T6 and a control end of the sixth transistor T6. The second capacitor C2 is connected in series between an output end of the second transistor T2 and a control end of the second transistor T2. The third capacitor C3 is connected in series between an input end of the tenth transistor T10 and a control end of the tenth transistor T10.

Optionally, for the gate driving circuit of the m-th cascade, the control end of the first transistor T1 is electrically connected to the first clock signal line CKL1, the input end of the second transistor T2 is electrically connected to the second clock signal line CKL2, the input end of the fourth transistor T4 is electrically connected to the first clock signal line CKL1, the control end of the fifth transistor T5 is electrically connected to the second clock signal line CKL2, and the input end of the sixth transistor T6 is electrically connected to the second clock signal line CKL2.

Optionally, for the gate driving circuit of the (m+1)th cascade, the control end of the first transistor T1 is electrically connected to the second clock signal line CKL2, the input end of the second transistor T2 is electrically connected to the first clock signal line CKL1, the input end of the fourth transistor T4 is electrically connected to the second clock signal line CKL2, the control end of the fifth transistor T5 is electrically connected to the first clock signal line CKL1, and the input end of the sixth transistor T6 is electrically connected to the first clock signal line CKL1.

Optionally, the gate driving circuit further includes an eleventh transistor T11 and a twelfth transistor T12. A control end of the eleventh transistor and a control end of the twelfth transistor T12 are electrically connected to the second power supply line VL2. An input end and an output end of the eleventh transistor T12 are electrically connected between the output end of the first transistor T1 and the control end of the second transistor T2. An input end of the twelfth transistor T12 is electrically connected to the control end of the fourth transistor T4, the output end of the seventh transistor T7, and the control end of the eighth transistor T8, and an output end of the twelfth transistor T12 is electrically connected to the control end of the sixth transistor T6 and the control end of the ninth transistor T9.

Optionally, the gate driving circuit further includes a thirteenth transistor T13. A control end of the thirteenth transistor T13 is electrically connected to a reset signal line CL, an input end of the thirteenth transistor T13 is electrically connected to the first power supply line VL1, and an output end of the thirteenth transistor T13 is electrically connected to the output end of the seventh transistor T7.

Continue to FIG. 3B, the gate driving circuit further includes a fourteenth transistor T14 to a sixteenth transistor T16. In the gate driving circuit illustrated in FIG. 3B, the control end of the sixth transistor T6 is electrically connected to a control end of the sixteenth transistor T16. An input end of the fourteenth transistor T14 is electrically connected to the input end of the seventh transistor T7, and an output end of the fourteenth transistor T14 is electrically connected to an input end of the fifteenth transistor T15. A control end of the fifteenth transistor T15 is electrically connected to the second power supply line VL2, and an output end of the fifteenth transistor T15 is electrically connected to a control end of the sixteenth transistor T16. An input end of the sixteenth transistor T16 is electrically connected to the control end of the sixteenth transistor T16, and an output end of the sixteenth transistor T16 is electrically connected to the control end of the ninth transistor T9.

Optionally, for the gate driving circuit of the nth cascade, the control end of the fourteenth transistor T14 is electrically connected to the first clock signal line CKL1. For the gate driving circuit of the (n+1)th cascade, the control end of the fourteenth transistor T14 is electrically connected to the second clock signal line CKL2.

A working principle of the gate driving circuit in FIG. 3A and FIG. 3B may be obtained by referring to the related art, and will not be repeated here.

It can be understood that the first gate driving circuit 101 and the second gate driving circuit 201 may be arranged to have the topological structures of the gate driving circuits illustrated in FIG. 3A and FIG. 3B, or may also be arranged to have circuit topological structures in other forms.

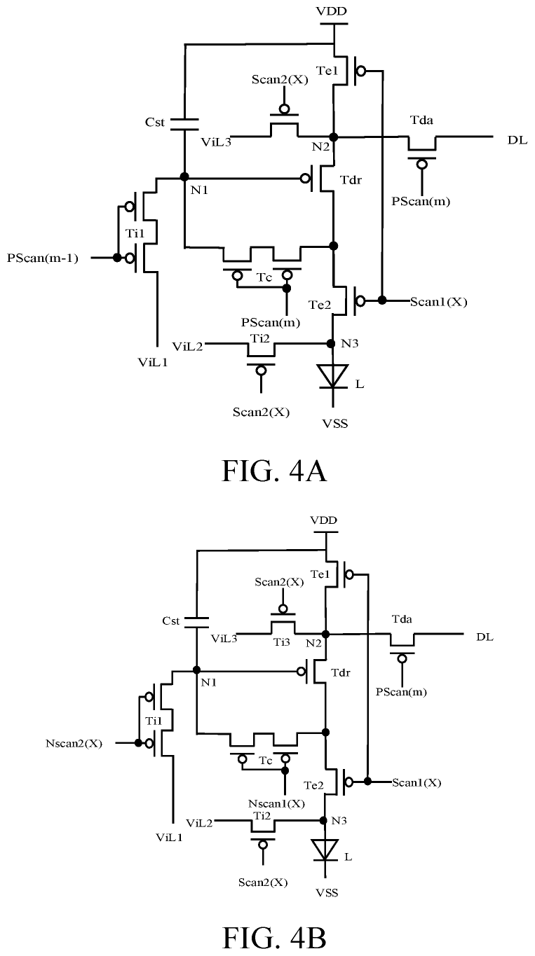

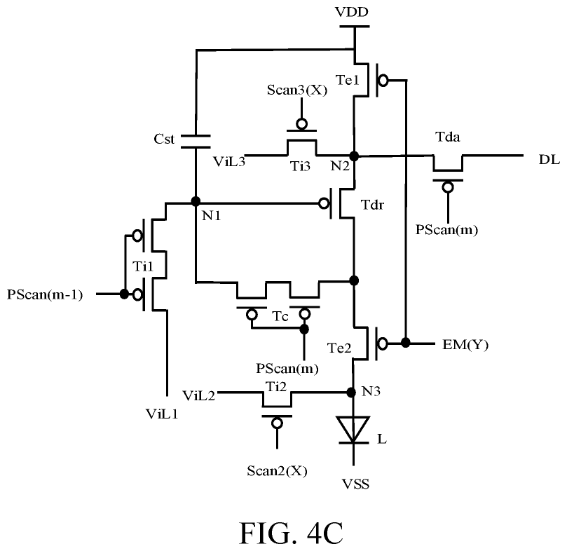

FIG. 4A to FIG. 4C are schematic structural views of a pixel driving circuit provided according to embodiments of the present disclosure. The plurality of transistors include a driving transistor Tdr, a data transistor Tda, a compensation transistor Tc, a first reset transistor Ti1, a second reset transistor Ti2, and one or more light emission control transistors.

A control end of the driving transistor Tdr is electrically connected to a first node N1, an input end of the driving transistor Tdr is electrically connected to a second node N2, and an output end of the driving transistor Tdr is electrically connected to a third node N3.

An input end of the data transistor Tda is electrically connected to a corresponding data line DL, and an output end of the data transistor Tda is electrically connected to the second node N2.

An input end of the compensation transistor Tc is electrically connected to the second node N2, and an output end of the compensation transistor Tc is electrically connected to the output end of the driving transistor Tdr.

An input end of the first reset transistor Ti1 is electrically connected to a corresponding first reset line ViL1, and an output end of the first reset transistor Ti1 is electrically connected to the first node N1.

An input end of the second reset transistor Ti2 is electrically connected to a corresponding second reset line ViL2, and an output end of the second reset transistor Ti2 is electrically connected to the third node N3.

An input end and an output end of the light emission control transistor and the driving transistor Tdr are connected in series between a first voltage end VDD and the light-emitting element L. Optionally, the light emission control transistors include a first light emission control transistor Te1 and a second light emission control transistor Te2. An input end and an output end of the first light emission control transistor Tel are electrically connected between the first voltage end VDD and the second node N2. An input end and an output end of the second light emission control transistor Te1 are electrically connected between the output end of the driving transistor Tdr and the third node N3. A cathode of the light-emitting element L is electrically connected to a second voltage end VSS.

Optionally, the compensation transistor Tc and the first reset transistor Ti1 may be silicon transistors or oxide transistors.

Optionally, the gate driving circuit further includes a third reset transistor Ti3. An input end of the third reset transistor Ti3 is electrically connected to a corresponding third reset line ViL3, and an output end of the third reset transistor Ti3 is electrically connected to the second node N2.

Optionally, a control end of the third reset transistor Ti3 may be electrically connected to the control end of the second reset transistor Ti2, so that the second reset transistor Ti2 and the third reset transistor Ti3 are synchronously turned on or off, as illustrated in FIG. 4A and FIG. 4B.

Optionally, the control end of the first reset transistor Ti1 and the control end of the data transistor Tda may be electrically connected to the gate driving circuits of different cascades of the same gate driving unit, and the control end of the compensation transistor Tc and the control end of the data transistor Tda may be electrically connected to the gate driving circuit of the same cascade of the same gate driving unit, as illustrated in FIG. 4A and FIG. 4C.

Continue to FIG. 4A to FIG. 4C, the pixel driving circuit further includes a storage capacitor Cst, which is connected in series between the first voltage end VDD and the control end of the driving transistor Tdr.

Herein, the first gate driving unit 10 and the second gate driving unit 20 are electrically connected to two ones of the compensation transistor Tc, the first reset transistor Ti1, the second reset transistor Ti2, the third reset transistor Ti3, and the light emission control transistor of each subpixel Pi.

Optionally, among the first gate driving unit 10 and the second gate driving unit 20, one is electrically connected to the control ends of the compensation transistors Tc of the plurality of subpixels Pi, and the other one is electrically connected to the control ends of the first reset transistors Ti1 of the plurality of subpixels Pi, or the other one is electrically connected to the control ends of the second reset transistors Ti2 of the plurality of subpixels Pi, or the other one is electrically connected to the control ends of the third reset transistors Ti3 of the plurality of subpixels Pi, or the other one is electrically connected to the control ends of the light emission control transistors of the plurality of subpixels Pi.

Optionally, among the first gate driving unit 10 and the second gate driving unit 20, one is electrically connected to the control ends of the first reset transistors Ti1 of the plurality of subpixels Pi, and the other one is electrically connected to the control ends of the second reset transistors Ti2 of the plurality of subpixels Pi, or the other one is electrically connected to the control ends of the third reset transistors Ti3 of the plurality of subpixels Pi, or the other one is electrically connected to the control ends of the light emission control transistors of the plurality of subpixels Pi.

Optionally, among the first gate driving unit 10 and the second gate driving unit 20, one is electrically connected to the control ends of the second reset transistors Ti2 of the plurality of subpixels Pi, and the other one is electrically connected to the control ends of the third reset transistors Ti3 of the plurality of subpixels Pi, or the other one is electrically connected to the control ends of the light emission control transistors of the plurality of subpixels Pi.

Optionally, among the first gate driving unit 10 and the second gate driving unit 20, one is electrically connected to the control ends of the third reset transistors Ti3 of the plurality of subpixels Pi, and the other one is electrically connected to the control ends of the light emission control transistors of the plurality of subpixels Pi.

Optionally, each first gate driving circuit 101 is electrically connected to a plurality of subpixels Pi in adjacent n rows, and each second gate driving circuit 201 is electrically connected to a plurality of subpixels Pi in adjacent n rows, so that the first gate driving circuit 101 and the second gate driving circuit 201 may be electrically connected to n rows of subpixels Pi at the same time, which reduces a number of the first gate driving circuits 101 and the second gate driving circuits 201 included in the display device, so as to reduce power consumption. Where n is greater than 1. Optionally, n may be equal to 2, 3, 4, 5, 6, 7, 8, etc. On a condition that n is equal to 4, the first gate driving circuit 101 of the first cascade and the second gate driving circuit 201 of the first cascade are both electrically connected to the plurality of subpixels Pi in the first to fourth rows, the first gate driving circuit 101 of the second cascade and the second gate driving circuit 201 of the second cascade are both electrically connected to the plurality of subpixels Pi in the fifth to eighth rows, and by analogy, a corresponding relationship between the plurality of subpixels Pi in other rows and the cascade of the first gate driving circuit 101 and the second gate driving circuit 201 is obtained.

Optionally, the plurality of subpixels Pi located in the (m+n)th row to the (m+n+3)th row are electrically connected to one first gate driving circuit 101 and one second gate driving circuit 201.

Optionally, continue to FIG. 2A and FIG. 4A, the first gate driving unit 10 is electrically connected to the control ends of the light emission control transistors of the plurality of subpixels Pi, the second gate driving unit 20 is electrically connected to the control ends of the second reset transistors Ti2 of the plurality of subpixels Pi, and the control ends of the third reset transistors Ti3 are electrically connected to the control ends of the second reset transistors Ti2, so that the light emission control transistors of the plurality of subpixels Pi are controlled to be turned on or off through the plurality of first gate driving circuits 101, and the second reset transistors Ti2 and the third reset transistors Ti3 are controlled to be turned on or off through the plurality of second gate driving circuits 201.

Optionally, each first gate driving circuit 101 is electrically connected to the control ends of the light emission control transistors of the plurality of subpixels Pi in four adjacent rows; and each second gate driving circuit 201 is electrically connected to the control ends of the second reset transistors Ti2 and the control ends of the third reset transistors Ti3 of the plurality of subpixels Pi in four adjacent rows.

Optionally, continue to FIG. 2B and FIG. 4B, the plurality of gate driving units further include a third gate driving unit 30 and a fourth gate driving unit 40 that share the clock signal and the power supply signal. The third gate driving unit 30 outputs a plurality of third scanning signals Nscan1 to the plurality of subpixels Pi in response a third start signal STV3, the clock signal, and the power supply signal. The fourth gate driving unit 40 outputs a plurality of fourth scanning signals Nscan2 to the plurality of subpixels Pi in response a fourth start signal STV4, the clock signal, and the power supply signal.

Herein, the third gate driving unit 30 includes a plurality of cascaded third gate driving circuits 301, the fourth gate driving unit 40 includes a plurality of cascaded fourth gate driving circuits 401, and the plurality of third gate driving circuits and the plurality of fourth gate driving circuits 401 are alternately arranged in the first direction. Optionally, the first gate driving unit 10 and the third gate driving unit 30 are arranged in parallel, and the second gate driving unit 20 and the fourth gate driving unit 40 are arranged in parallel.

Optionally, the compensation transistor Tc and the first reset transistor Ti1 are oxide transistors. The third gate driving unit 30 is electrically connected to the control ends of the compensation transistors Tc of the plurality of subpixels Pi, and the fourth gate driving unit 40 is electrically connected to the control ends of the first reset transistors Ti1 of the plurality of subpixels Pi.

Optionally, each third gate driving circuit 301 is electrically connected to the control ends of the compensation transistors Tc of the plurality of subpixels Pi in four adjacent rows, and each fourth gate driving circuit 401 is electrically connected to the control ends of the first reset transistors Ti1 of the plurality of subpixels Pi in four adjacent rows.

Optionally, continue to FIG. 2C and FIG. 4C, the first gate driving unit 10 is electrically connected to the control ends of the second reset transistors Ti2 of the plurality of subpixels Pi, and the second gate driving unit 20 is electrically connected to the control ends of the third reset transistors Ti3 of the plurality of subpixels Pi.

Optionally, each first gate driving circuit 101 is electrically connected to the control ends of the second reset transistors Ti2 of the plurality of subpixels Pi in four adjacent rows; and each second gate driving circuit 201 is electrically connected to the control ends of the third reset transistors Ti3 of the plurality of subpixels Pi in four adjacent rows.

Optionally, continue to FIG. 2C and FIG. 4C, the plurality of gate driving units further include a fifth gate control unit including a plurality of fifth gate driving circuits. Each fifth gate driving circuit 501 is electrically connected to the control ends of the light emission control transistors of the plurality of subpixels Pi in two adjacent rows.

Optionally, continue to FIG. 2A to FIG. 2C, the plurality of gate driving units further include a sixth gate driving unit 60 including a plurality of cascaded sixth gate driving circuits 601. Herein, each sixth gate driving circuit 601 is electrically connected to the control ends of the data transistors Tda of the plurality of subpixels Pi in the same row.

Optionally, each sixth gate driving circuit 601 is electrically connected to the control ends of the first reset transistors Ti1 of the plurality of subpixels Pi located in the same row, and the control end of the compensation transistor Tc is electrically connected to the control end of the data transistor Tda, as illustrated in FIG. 2A, FIG. 2C, FIG. 4A, and FIG. 4C.

Optionally, the display panel includes a first sub-region A1 and a second sub-region A2 located on opposite sides of the plurality of subpixels Pi. Herein, the first gate driving unit 10 and the second gate driving unit 20 are located in the first sub-region A1, the sixth gate driving unit 60 is located in at least one of the first sub-region A1 and the second sub-region A2.

Optionally, continue to FIG. 2A, the first gate driving unit 10 and the second gate driving unit 20 are located in the first sub-region A1, and the sixth gate driving unit 60 is located in the second sub-region A2.

Optionally, continue to FIG. 2B, the first gate driving unit 10, the second gate driving unit 20, the third gate driving unit 30, and the fourth gate driving unit 40 are located in the first sub-region A1, the first gate driving unit 10 and the second gate driving unit 20 are located on a side of the third gate driving unit 30 and the fourth gate driving unit 40 close to the sixth gate driving unit 60, and the sixth gate driving unit 60 is located in the second sub-region A2.

Optionally, continue to FIG. 2C, the first gate driving unit 10 and the second gate driving unit 20 are located in the first sub-region A1, the sixth gate driving unit 60 is located in the first sub-region A1 and the second sub-region A2, and the fifth gate driving unit 50 is located in the second sub-region A2. The fifth gate driving unit 50 is located on a side of the sixth gate driving unit 60 away from the first gate driving unit 10 and the second gate driving unit 20, and the first gate driving unit 10 and the second gate driving unit 20 are located on a side of the sixth gate driving unit 60 away from the fifth gate driving unit 50.

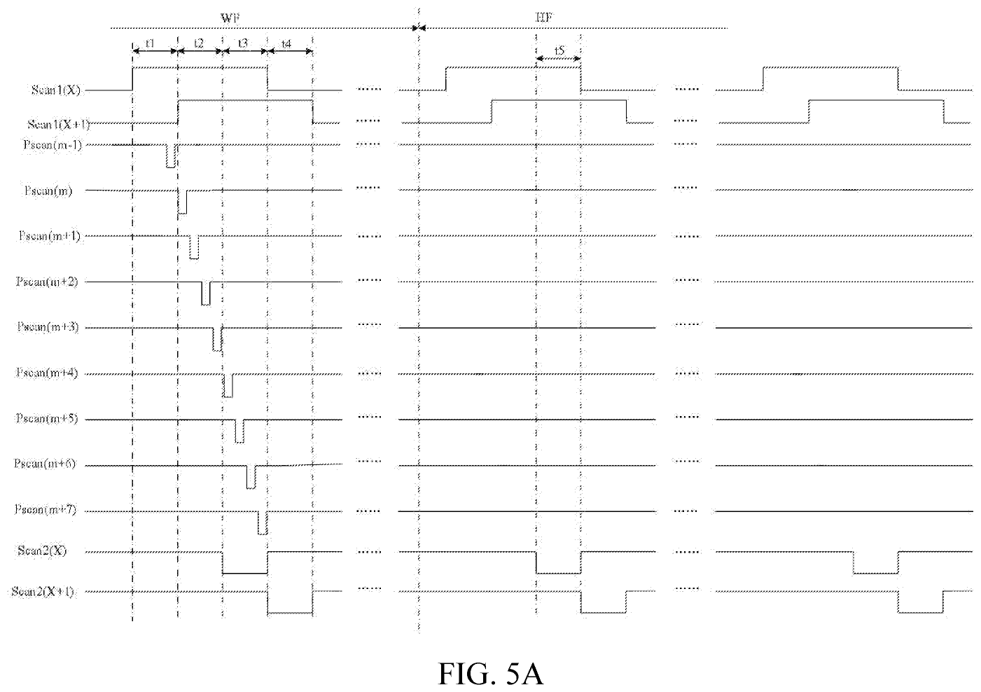

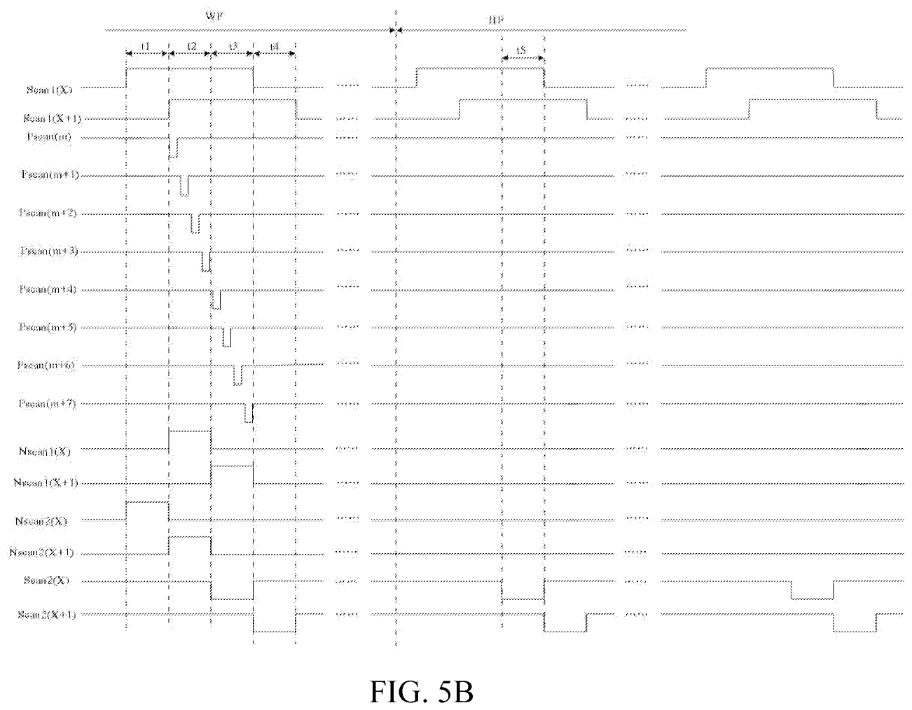

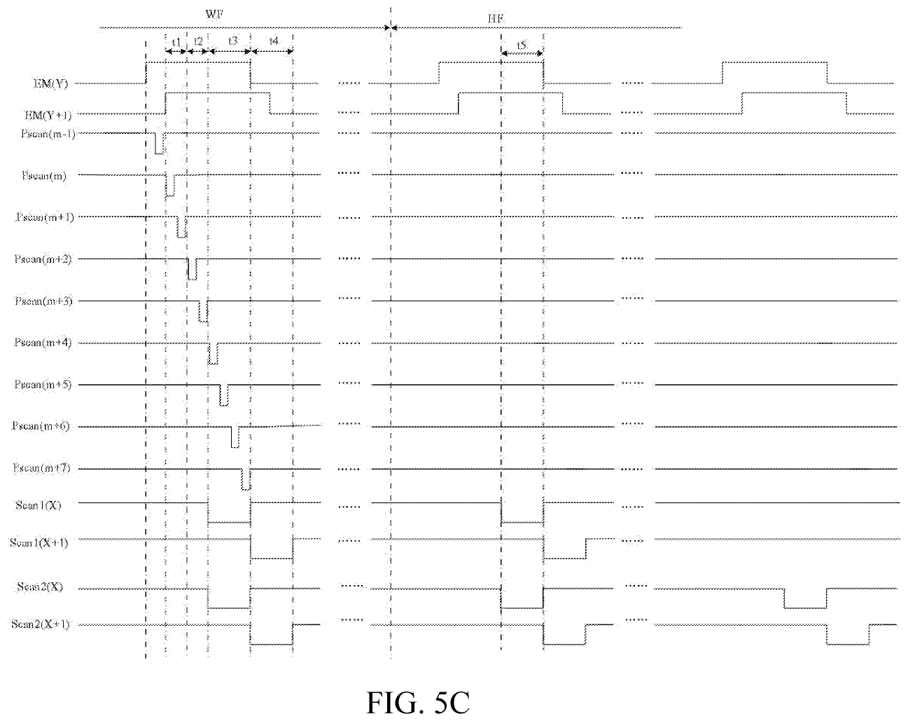

FIG. 5A to FIG. 5C are timing diagrams provided according to embodiments of the present disclosure. By taking that each first gate driving circuit 101 and each second gate driving circuit 201 are both electrically connected to adjacent four rows of subpixels Pi as an example, the working principle of the display device is described, where X≥1 and Y≥1.

Continue to FIG. 2A, FIG. 4A, and FIG. 5A, in a first phase t1, a X-th level first scanning signal Scan1(X) output by the first gate driving circuit 101 of the X-th cascade is at a high level, so that the light emission control transistors of the subpixels Pi in the m-th row to the (m+3)th row are turned off; and a (m−1)th level scanning signal Pscan(m−1) output by the sixth gate driving circuit 601 of the (m−1)th cascade is at a low level, so that the first reset transistors Ti1 of the subpixels Pi located in the m-th row are turned on, and the first reset signal transmitted by the first reset line ViL1 resets gates of the driving transistors Tdr.

In a second phase t2, a m-th level scanning signal Pscan(m) output by the sixth gate driving circuit 601 of the m-th cascade is at a low level, so that the data transistors Tda and the compensation transistors Tc of the subpixels Pi located in the m-th row are turned on, the data signal transmitted by the data line DL is written into the gates of the driving transistors Tdr and the storage capacitors Cst; and the first reset transistors Ti1 of the subpixels Pi located in the (m+1)th row are turned on, and the first reset signal transmitted by the first reset line ViL1 resets the gates of the driving transistors Tdr. Afterwards, a (m+1)th level scanning signal Pscan(m+1) output by the sixth gate driving circuit 601 of the (m+1)th cascade is at a low level, so that the data transistors Tda and the compensation transistors Tc of the subpixels Pi located in the (m+1)th row are turned on, and the data signal transmitted by the data line DL is written into the gates of the driving transistors Tdr and the storage capacitors Cst; and the first reset transistors Ti1 of the subpixels Pi located in the (m+2)th row are turned on, and the first reset signal transmitted by the first reset line ViL1 resets the gates of the driving transistors Tdr. Afterwards, a (m+2)th level scanning signal Pscan(m+2) output by the sixth gate driving circuit 601 of the (m+2)th cascade is at a low level, so that the data transistors Tda and the compensation transistors Tc of the subpixels Pi located in the (m+2)th row are turned on, and the data signal transmitted by the data line DL is written into the gates of the driving transistors Tdr and the storage capacitors Cst; and the first reset transistors Ti1 of the subpixels Pi located in the (m+3)th row are turned on, and the first reset signal transmitted by the first reset line ViL1 resets the gates of the drive transistors Tdr. Finally, a (m+3)th level scanning signal Pscan(m+3) output by the sixth gate driving circuit 601 of the (m+3)th cascade is at a low level, so that the data transistors Tda and the compensation transistors Tc of the subpixels Pi located in the (m+3)th row are turned on, and the data signal transmitted by the data line DL is written into the gates of the driving transistors Tdr and the storage capacitors Cst; and the first reset transistors Ti1 of the subpixels Pi located in the (m+4)th row are turned on, and the first reset signal transmitted by the first reset line ViL1 resets the gates of the driving transistors Tdr.

In a third phase t3, a X-th level second scanning signal Scan2(X) output by the second gate driving circuit 201 of the X-th cascade is at a low level, and the second reset transistors Ti2 and the third reset transistors Ti3 of the subpixels located in the m-th row to the (m+3)th row are turned on, the second reset signal transmitted by the second reset line ViL2 resets the third node N3, and the third reset signal transmitted by the third reset line ViL3 applies a bias voltage to the second node N2, thereby relieving the hysteresis effect of the drive transistors Tdr and relieving the flicker. In addition, the subpixels Pi located in the (m+4)th row to the (m+7)th row perform a same operation in the third phase t3 as the subpixels Pi located in the m-th row to the (m+3)th row in the second phase t2.

In a fourth phase t4, the X-th level first scanning signal Scan1(X) output by the first gate driving circuit 101 of the X-th cascade is at a low level, so that the light emission control transistors of the subpixels Pi located in the m-th row to the (m+3)th are turned on, and the light-emitting elements L emit light.

Optionally, the display device may display with a variable refresh rate. Correspondingly, when the display panel is displaying, it includes writing frames WF and holding frames HF. Herein, the writing frame WF may include the first phase t1 to the fourth phase t4. In the holding frame HF, the first scanning signal Scan1 output by the first gate driving circuit 101 has a high level state and a low level state, the second scanning signal Scan2 output by the second gate driving circuit 201 has a high level state and a low level state, and the scanning signal Pscan output by the sixth gate driving unit 60 has a low level state. A fifth phase t5 is included in the holding frame HF to reset the third node N3 of the subpixels Pi of the corresponding row and apply a bias voltage to the second node N2. For example, in the fifth phase t5, the X-th level first scanning signal Scan1(X) output by the first gate driving circuit 101 of the X-th cascade is at a high level, so that the light emission control transistors of the subpixels Pi located in the m-th row to the (m+3)th row are turned off; and the X-th level second scanning signal Scan2(X) output by the second gate driving circuit 201 of the X-th cascade is at a low level, the second reset transistors Ti2 and the third reset transistors Ti3 of the subpixels Pi located in the m-th row to the (m+3)th row are turned on, the second reset signal transmitted by the second reset line ViL2 resets the third node N3, and the third reset signal transmitted by the third reset line ViL3 applies a bias voltage to the second node N2, thereby relieving the hysteresis effect of the drive transistors Tdr and relieving the flicker.

Continue to FIG. 4B and FIG. 5B, in the first phase t1, the X-th level first scanning signal Scan1(X) output by the first gate driving circuit 101 of the X-th cascade is at a high level, so that the light emission control transistors of the subpixels Pi located in the m-th row to the (m+3)th row are turned off; The X-th level fourth scanning signal Nscan2(X) output by the fourth gate driving circuit 401 of the X-th cascade is at a low level, so that the first reset transistors Ti1 of the subpixels Pi located in the m-th row to the (m+3)th row are turned on, the first reset signal transmitted by the first reset line ViL1 resets the gates of the driving transistors Tdr of the subpixels Pi located in the m-th row to the (m+3)th row.

In the second phase t2, the X-th level third scanning signal Nscan1(X) output by the third gate driving circuit 301 of the X-th cascade is at a high level, so that the compensation transistors Tc of the subpixels Pi located in the m-th row to the (m+3)th row are turned on; and the m-th scanning signal Pscan(m) output by the sixth gate driving circuit 601 of the m-th cascade is at a low level, so that the data transistors Tda of the subpixels Pi located in the m-th row are turned on, and the data signal transmitted by the data line DL is written into the gates of the drive transistors Tdr and the storage capacitors Cst. Afterwards, the (m+1)th level scanning signal Pscan(m+1) output by the sixth gate driving circuit 601 of the (m+1)th cascade is at a low level, so that the data transistors Tda of the subpixels Pi located in the (m+1)th row are turned on, and the data signal transmitted by the data line DL is written into the gates of the drive transistors Tdr and the storage capacitors Cst. Afterwards, the (m+2)th level scanning signal Pscan(m+2) output by the sixth gate driving circuit 601 of the (m+2)th cascade is at a low level, so that the data transistors Tda of the subpixels Pi located in the (m+2)th row are turned on, and the data signal transmitted by the data line DL is written into the gates of the drive transistors Tdr and the storage capacitors Cst. Finally, the (m+3)th level scanning signal Pscan(m+3) output by the sixth gate driving circuit 601 of the (m+3)th cascade is at a low level, so that the data transistors Tda of the subpixels Pi located in the (m+3)th row are turned on, and the data signal transmitted by the data line DL is written into the gates of the driving transistors Tdr and the storage capacitors Cst. The (X+1)th level fourth scanning signal Nscan2(X+1) output by the fourth gate driving circuit 401 of the (X+1)th cascade is at a low level, so that the first reset transistors Ti1 of the subpixels Pi located in the (m+4)th row to the (m+7)th row are turned on, and the first reset signal transmitted by the first reset line ViL1 resets the gates of the driving transistors Tdr of the subpixels Pi located in the (m+4)th row to the (m+7)th row.

In the third phase t3, the X-th level second scanning signal Scan2(X) output by the second gate driving circuit 201 of the X-th cascade is at a low level, the second reset transistors Ti2 and the third reset transistors Ti3 of the subpixels Pi located in the m-th row to the (m+3)th row are turned on, the second reset signal transmitted by the second reset line ViL2 resets the third node N3, and the third reset signal transmitted by the third reset line ViL3 applies a bias voltage to the second node N2, thereby relieving the hysteresis effect of the drive transistors Tdr and relieving the flicker. In addition, the subpixels Pi located in the (m+4)th row to the (m+7)th row perform the same operation in the third phase t3 as the subpixels Pi located in the m-th row to the (m+3)th row in the second phase t2.

In the fourth phase t4, the X-th level first scanning signal Scan 1(X) output by the first gate driving circuit 101 of the X-th cascade is at a low level, so that the light emission control transistors of the subpixels Pi located in the m-th row to the (m+3)th row are turned on, and the light-emitting elements L emit light.

Optionally, in the holding frame HF, the first scanning signal Scan1 output by the first gate driving circuit 101 has a high level state and a low level state, and the second scanning signal Scan2 output by the second gate driving circuit 201 has a high level state and low level state, the scanning signals output by the third gate driving unit 30 and the fourth gate driving unit 40 have a low level state, and the scanning signal output by the sixth gate driving unit 60 has a low level state. A fifth phase t5 is included in the holding frame HF to reset the third node N3 of the subpixel Pi of the corresponding row and apply a bias voltage to the second node N2. For example, in the fifth phase t5, the X-th level first scanning signal Scan1(X) output by the first gate driving circuit 101 of the X-th cascade is at a high level, so that the light emission control transistors of the subpixels located in the m-th row to the (m+3)th row are turned off; and the X-th level second scanning signal Scan2(X) output by the second gate driving circuit 201 of the X-th cascade is at a low level, and the second reset transistors Ti2 and the third reset transistors Ti3 of the subpixels Pi located in the m-th row to the (m+3)th row are turned on, the second reset signal transmitted by the second reset line ViL2 resets the third node N3, and the third reset signal transmitted by the third reset line ViL3 applies a bias voltage to the second node N2, thereby relieving the hysteresis effect of the drive transistors Tdr and relieving the flicker.

Continue to FIG. 4C and FIG. 5C, in the first phase t1, the Y-th level scanning signal EM(Y) output by the fifth gate driving circuit 501 of the Y-th cascade is at a high level, so that the light emission control transistors of the subpixels Pi in the m-th row to the (m+1)th row are turned off; and the (m−1)th level scanning signal Pscan(m−1) output by the sixth gate driving circuit 601 of the (m−1)th cascade is at a low level, so that the first reset transistors Ti1 of the subpixels Pi located in the m-th row are turned on, and the first reset signal transmitted by the first reset line ViL1 resets the gates of the driving transistors Tdr.

In the second phase t2, the (Y+1)th level scanning signal EM(Y+1) output by the fifth gate driving circuit 501 of the (Y+1)th cascade is at a high level, so that the light emission control transistors of the subpixels Pi located in the (m+2)th row to the (m+3)th row are turned off; the m-th level scanning signal Pscan(m) output by the sixth gate driving circuit 601 of the m-th cascade is at a low level, so that the data transistors Tda and the compensation transistors Tc of the subpixels Pi located in the m-th row are turned on, and the data signal transmitted by the data line DL is written into the gates of the drive transistors Tdr and the storage capacitors Cst; and the first reset transistors Ti1 of the subpixels Pi located in the (m+1)th row are turned on, and the first reset signal transmitted by the first reset line ViL1 resets the gates of the driving transistors Tdr. Afterwards, the (m+1)th level scanning signal Pscan(m+1) output by the sixth gate driving circuit 601 of the (m+1)th cascade is at a low level, so that the data transistors Tda and the compensation transistors Tc of the subpixels Pi located in the (m+1)th row are turned on, and the data signal transmitted by the data line DL is written into the gates of the driving transistors Tdr and the storage capacitors Cst; and the first reset transistors Ti1 of the subpixels Pi located in the (m+2)th row are turned on, and the first reset signal transmitted by the first reset line ViL1 resets the gates of the driving transistors Tdr. Afterwards, the (m+2)th level scanning signal Pscan(m+2) output by the sixth gate driving circuit 601 of the (m+2)th cascade is at a low level, so that the data transistors Tda and the compensation transistors Tc of the subpixels Pi located in the (m+2)th row are turned on, and the data signal transmitted by the data line DL is written into the gates of the driving transistors Tdr and the storage capacitors Cst; and the first reset transistors Ti1 of the subpixels Pi located in the (m+3)th row are turned on, and the first reset signal transmitted by the first reset line ViL1 resets the gates of the drive transistors Tdr. Finally, the (m+3)th level scanning signal Pscan(m+3) output by the sixth gate driving circuit 601 of the (m+3)th cascade is at a low level, so that the data transistors Tda and the compensation transistors Tc of the subpixels Pi located in the (m+3)th row are turned on, and the data signal transmitted by the data line DL is written into the gates of the driving transistors Tdr and the storage capacitors Cst; and the first reset transistors Ti1 of the subpixels Pi located in the (m+4)th row are turned on, and the first reset signal transmitted by the first reset line ViL1 resets the gates of the driving transistors Tdr.

In the third phase t3, the X-th level first scanning signal Scan1(X) output by the first gate driving circuit 101 of the X-th cascade is at a low level, and the second reset transistors Ti2 of the subpixels Pi located in the (m+2)th row to the (m+3)th row are turned on; and the X-th level second scanning signal Scan2(X) output by the second gate driving circuit 201 of the X-th cascade is at a low level, the third reset transistors Ti3 of the pixels Pi located in the (m+2)th row to the (m+3)th row are turned on, the second reset signal transmitted by the second reset line ViL2 resets the third node N3, and the third reset signal transmitted by the third reset line ViL3 applies a bias voltage to the second node N2, thereby relieving the hysteresis effect of the drive transistor Tdr and relieving the flicker. In addition, the subpixels Pi located in the (m+4)th row to the (m+7)th row perform the same operation in the third phase t3 as the subpixels Pi located in the m-th row to the (m+3)th row in the second phase t2.

In the fourth phase t4, the Y-th level scanning signal EM(Y) output by the fifth gate driving circuit 501 of the Y-th cascade is at a low level, so that the light emission control transistors of the subpixels Pi located in the m-th row to the (m+3)th row are turned on, and the light-emitting elements L emit light.

Optionally, in the holding frame HF, the first scanning signal Scan1 output by the first gate driving circuit 101 has a high level state and a low level state, and the second scanning signal Scan2 output by the second gate driving circuit 201 has a high level state and low level state, the scanning signal EM output by the fifth gate driving unit 50 has a high level state and a low level state, and the scanning signal Pscan output by the sixth gate driving unit 60 has a low level state. A fifth phase t5 is included in the holding frame HF to reset the third node N3 of the subpixel Pi of the corresponding row and apply a bias voltage to the second node N2. For example, in the fifth phase t5, the Y-th level scanning signal EM(Y) output by the fifth gate driving circuit 501 of the Y-th cascade is at a high level, so that the light emission control transistors of the subpixels Pi located in the m-th row to the (m+3)th row are turned off; and the X-th level first scanning signal Scan1(X) output by the first gate driving circuit 101 of the X-th cascade is at a low level, and/or, the X-th level second scanning signal Scan2(X) output by the second gate driving circuit 201 of the X-th cascade is at a low level, so that at least one of the second reset transistors Ti2 and the third reset transistors Ti3 of the subpixels Pi located in the m-th row to the (m+3)th row is turned on, so as to reset the third node N3 and/or apply a bias voltage to the second node N2, which relieves the hysteresis effect of the driving transistors Tdr and relieves the flicker.

Optionally, within the duration corresponding to the holding frame HF, a frequency of the second scanning signal Scan2 output by the second gate driving circuit 201 is greater than a frequency of the first scanning signal Scan1 output by the first gate driving circuit 101, so as to relieve the flicker and save power consumption. Optionally, within the duration corresponding to the holding frame HF, the frequency of the second scanning signal Scan2 output by the second gate driving circuit 201 is 240 Hz, and the frequency of the first scanning signal Scan1 output by the first gate driving circuit 101 is 120 Hz.

In this paper, specific examples are used to illustrate the principles and implementation methods of the present disclosure, and the descriptions of the above embodiments are only used to help understand the methods and core ideas of the present disclosure. At the same time, for those skilled in the art, based on the idea of the present disclosure, there will be changes in the specific implementation and application scope. In summary, the contents of this specification should not be construed as a limitation of the present disclosure.

1. A display device, comprising:
a display panel, comprising a plurality of subpixels each comprising a light-emitting element and a pixel driving circuit electrically connected to the light-emitting element and comprising a plurality of transistors; and
a plurality of gate driving units, at least comprising a first gate driving unit and a second gate driving unit electrically connected to the plurality of subpixels and sharing a clock signal and a power supply signal,
wherein the first gate driving unit comprises a plurality of cascaded first gate driving circuits and is configured to output a plurality of first scanning signals to the plurality of subpixels in response to a first startup signal, the clock signal, and the power supply signal;
the second gate driving unit comprises a plurality of cascaded second gate driving circuits and is configured to output a plurality of second scanning signals to the plurality of subpixels in response a second startup signal, the clock signal, and the power supply signal;
each of the subpixels comprises one of the transistors which is turned on in response to a corresponding one of the first scanning signals and another one of transistors which is turned on in response to a corresponding one of the second scanning signals; and
the plurality of first gate driving circuits and the plurality of second gate driving circuits are alternately arranged in a first direction.

2. The display device according to claim 1, wherein the first gate driving circuits and the second gate driving circuits have a same circuit topological structure.

3. The display device according to claim 1, wherein the plurality of transistors comprise:
a driving transistor, comprising a control end electrically connected to a first node, an input end electrically connected to a second node, and an output end electrically connected to a third node;
a data transistor, comprising an input end electrically connected to a corresponding data line and an output end electrically connected to the second node;
a compensation transistor, comprising an input end electrically connected to the second node and an output end electrically connected to the output end of the driving transistor;
a first reset transistor, comprising an input end electrically connected to a corresponding first reset line and an output end electrically connected to the first node;
a second reset transistor, comprising an input end electrically connected to a corresponding second reset line and an output end electrically connected to the third node;
a third reset transistor, comprising an input end electrically connected to a corresponding third reset line and an output end electrically connected to the second node; and
a light emission control transistor, comprising an input end and an output end connected in series with the driving transistor between a first voltage end and the light-emitting element; and
wherein the first gate driving unit and the second gate driving unit are electrically connected to two ones of the compensation transistor, the first reset transistor, the second reset transistor, the third reset transistor, and the light emission control transistor of each of the plurality of subpixels.

4. The display device according to claim 3, wherein the first gate driving unit is electrically connected to a control end of the light emission control transistor of each of the plurality of subpixels, the second gate driving unit is electrically connected to a control end of the second reset transistor of each of the plurality of subpixels, and a control end of the third reset transistor is electrically connected to the control end of the second reset transistor.

5. The display device according to claim 4, wherein the compensation transistor and the first reset transistor are oxide transistors;
the plurality of gate driving units further comprise a third gate driving unit and a fourth gate driving unit share the clock signal and the power supply signal, the third gate driving unit is electrically connected to a control end of the compensation transistor of each of the plurality of subpixels, and the fourth gate driving unit is electrically connected to a control end of the first reset transistor of each of the plurality of subpixels; and
the third gate driving unit comprises a plurality of cascaded third gate driving circuits, the fourth gate driving unit comprises a plurality of cascaded fourth gate driving circuits, and the plurality of third gate driving circuits and the plurality of fourth gate driving circuits are alternately arranged in the first direction.

6. The display device according to claim 5, wherein each of the first gate driving circuits is electrically connected to the control end of the light emission control transistor of each of the plurality of subpixels located in adjacent four rows;
each of the second gate driving circuits is electrically connected to the control end of the second reset transistor and the control end of the third reset transistor of each of the plurality of subpixels located in adjacent four rows;
each of the third gate driving circuits is electrically connected to the control end of the compensation transistor of each of the plurality of subpixels located in adjacent four rows; and
each of the fourth gate driving circuits is electrically connected to the control end of the first reset transistor of each of the plurality of subpixels located in adjacent four rows.

7. The display device according to claim 3, wherein the first gate driving unit is electrically connected to a control end of the second reset transistor of each of the plurality of subpixels, and the second gate driving unit is electrically connected to a control end of the third reset transistor of each of the plurality of subpixels.

8. The display device according to claim 7, wherein each of the first gate driving circuits is electrically connected to the control end of the second reset transistor of each of the plurality of subpixels located in adjacent four rows, and each of the second gate driving circuits is electrically connected to the control end of the third reset transistor of each of the plurality of subpixels located in adjacent four rows.

9. The display device according to claim 7, wherein the plurality of gate driving units further comprise a fifth gate control unit comprising a plurality of fifth gate driving circuits, and each of the fifth gate driving circuits is electrically connected to a control end of the light emission control transistor of each of the plurality of subpixels located in adjacent two rows.

10. The display device according to claim 3, wherein the plurality of gate driving units further comprise a sixth gate driving unit comprising a plurality of cascaded sixth gate driving circuits, and each of the sixth gate driving circuits is electrically connected to a control end of the data transistor of each of the plurality of subpixels located in a same row.

11. The display device according to claim 10, wherein each of the sixth gate driving circuits is electrically connected to a control end of the first reset transistor of each of the plurality of subpixels located in a same row, and a control end of the compensation transistor is electrically connected to the control end of the data transistor.

12. The display device according to claim 10, wherein the display panel comprises a first sub-region and a second sub-region located on opposite sides of the plurality of subpixels; and
wherein the first gate driving unit and the second gate driving unit are located in the first sub-region, and the sixth gate driving unit is located in at least one of the first sub-region and the second sub-region.

13. The display device according to claim 1, wherein each of the first gate driving circuits comprises:
a first transistor, comprising a control end electrically connected to one of a first clock signal line and a second clock signal line, and an input end electrically connected to a second power supply line;
a second transistor, comprising a control end electrically connected to an output end of the first transistor, and an input end electrically connected to the other one of the first clock signal line and the second clock signal line;
a third transistor, comprising a control end electrically connected to the output end of the first transistor, and an input end electrically connected to a first power supply line;
a fourth transistor, comprising an output end electrically connected to the output end of the first transistor, and an input end electrically connected to one of the first clock signal line and the second clock signal line;
a fifth transistor, comprising a control end electrically connected to the other one of the first clock signal line and the second clock signal line, and an input end electrically connected to an output end of the second transistor;
a sixth transistor, comprising an input end electrically connected to one of the first clock signal line and the second clock signal line, and an output end electrically connected to an output end of the third transistor;
a seventh transistor, comprising an input end receiving a startup signal, and an output end electrically connected to a control end of the fourth transistor and a control end of the sixth transistor;
an eighth transistor, comprising a control end electrically connected to the output end of the seventh transistor, an input end electrically connected to the first power supply line, and an output end electrically connected to an output end of the fifth transistor;
a ninth transistor, comprising a control end electrically connected to the output end of the seventh transistor and an input end electrically connected to the second power supply line;
a tenth transistor, comprising a control end electrically connected to the output end of the fifth transistor and an input end electrically connected to the first power supply line, wherein an output end of the ninth transistor and an output end of the tenth transistor are both electrically connected to a signal output end of a corresponding one of the first gate driving circuits, and the signal output end is configured to output a scanning signal;
a first capacitor, connected between the output end of the sixth transistor and a control end of the sixth transistor;
a second capacitor, connected between an output end of the second transistor and the control end of the second transistor; and
a third capacitor, connected between the input end of the tenth transistor and the control end of the tenth transistor.

14. The display device according to claim 13, wherein each of the first gate driving circuits further comprises:
an eleventh transistor, comprising a control end electrically connected to the second power supply line, an input end, and an output end electrically, both of the input end and the output end connected between the output end of the first transistor and the control end of the second transistor; and
a twelfth transistor, comprising a control end electrically connected to the second power supply line, an input end electrically connected to the control end of the fourth transistor, the output end of the seventh transistor, and the control end of the eighth transistor, and an output end electrically connected to the control end of the sixth transistor and the control end of the ninth transistor.

15. The display device according to claim 13, wherein each of the first gate driving circuits further comprises:
a thirteenth transistor, comprising a control end electrically connected to a reset signal line, an input end electrically connected to the first power supply line, and an output end electrically connected to the output end of the seventh transistor.

16. The display device according to claim 13, wherein each of the first gate driving circuits further comprises:
a fourteenth transistor, comprising an input end electrically connected to the input end of the seventh transistor, and a control end electrically connected to the first clock signal line or the second clock signal line;
a fifteenth transistor, comprising an input end electrically connected to an output end of the fourteenth transistor, and a control end electrically connected to the second power supply line; and
a sixteenth transistor, comprising a control end electrically connected to the control end of the sixth transistor and an output end of the fifteenth transistor, an input end electrically connected to the control end thereof, and an output end electrically connected to the control end of the ninth transistor.
